(19) United States
(12) Patent Application Publication
(10) Pub. No.: US 2010/0316851 A1
(43) Pub. Date: Dec. 16, 2010

(54) PROCESS FOR PRODUCING PATTERNED FILM-FORMED MEMBER, PATTERNED FILM-FORMED MEMBER, ELECTROOPTICAL DEVICE, AND ELECTRONIC APPARATUS

(75) Inventors: Toshimitsu HIRAI, Hokuto (JP); Eiji OKAMOTO, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/788,440

(22) Filed: May 27, 2010

(30) Foreign Application Priority Data
Jun. 12, 2009 (JP) 2009-140909
May 17, 2010 (JP) 2010-112888

(51) Int. Cl. B32B 3/10; B05D 5/12

(52) U.S. Cl. 428/195.1; 427/58

(57) ABSTRACT

A process for producing a patterned film-formed member, includes: a surface treating step of subjecting a surface of a glassy material layer within a base material having a conductive film formed on a portion of the glassy material layer to a water repellent treatment and also subjecting a surface of the conductive film to a lower degree of water repellent treatment than that for the glassy material layer; an applying step of applying a functional liquid containing an aqueous dispersion medium and metal particles which are a constituent material of a metal film and are dispersed in the aqueous dispersion medium onto the conductive film; and a solidifying step of solidifying the applied functional liquid thereby forming the metal film on the conductive film.

### BACKGROUND

1. Technical Field

The present invention relates to a process for producing a patterned film-formed member, a patterned film-formed member, an electrooptical device, and an electronic apparatus.

2. Related Art

As a patterned film-formed member, for example, a touch panel in which electrode lines are formed on a glass substrate is known. The electrode line is formed of a transparent electrode film as a conductive film having a high visible light transmittance on the glass substrate. The transparent conductive film has electric conductivity, however, for the purpose of improving the functionality of the touch panel, a metal film having a low electric resistivity is further formed on the transparent conductive film so as to decrease the electric resistance in some cases. At this time, in the case where a liquid material which is a material of the metal film is applied onto the transparent conductive film, a lyophilic region should be formed on the surface of the transparent conductive film so as to allow the liquid material of the metal film to wet and spread on the region, and a liquid repellent region which repels the liquid material of the metal film should be formed on a region of the surface of the glass substrate other than the transparent conductive film. Therefore, as a method of forming a lyophilic region and a liquid repellent region, for example, a method of selectively forming a lyophilic region and a liquid repellent region in one base material as follows is known (see, for example, JP-A-2003-209339). After a photocatalyst-containing layer having liquid repellency is formed on a substrate, using a mask having a predetermined pattern formed thereon, the photocatalyst-containing layer is irradiated with active light through the mask, whereby a photocatalytic reaction occurs only in a region irradiated with the active light and a lyophilic region is formed.

However, in the above-described method, a plurality of steps, i.e., a step of forming a water repellent region and a step of forming a lyophilic region were required, and also it was necessary to selectively perform a surface treatment for a predetermined region using a mask, and therefore, there was a problem that the production process was complicated.

### SUMMARY

An advantage of some aspects of the invention is to solve at least a part of the above-described problem and the invention can be realized as the following aspects or application examples.

### Application Example 1

A process for producing a patterned film-formed member according to this application example includes: a surface treating step of subjecting a surface of a glassy material layer within a base material having a conductive film formed on a portion of the glassy material layer to a water repellent treatment and also subjecting a surface of the conductive film to a lower degree of water repellent treatment than that for the glassy material layer; an applying step of applying a functional liquid containing an aqueous dispersion medium and metal particles which are a constituent material of a metal film and are dispersed in the aqueous dispersion medium onto the conductive film; and a solidifying step of solidifying the applied functional liquid thereby forming the metal film on the conductive film.

According to this configuration, on the surface of the glassy material layer, a water repellent region is formed and on the surface of the conductive film, a water repellent region whose water repellency is lower than that of the surface of the glassy material layer is formed. That is, in this surface treating step, a contrasting pattern of a region having high water repellency and a region having low water repellency can be formed at the same time. Further, in other words, the surface of the glassy material layer can be made water repellent, and the hydrophilicity of the surface of the conductive film can be maintained. Further, when an aqueous functional liquid is applied onto the conductive film, the applied functional liquid wets and spreads on the surface of the conductive film having hydrophilicity. Further, in a boundary region between the glassy material layer and the conductive film, since the surface of the glassy material layer is water repellent, the functional liquid coming into contact with the surface of the glassy material layer is repelled from the glassy material layer and moves in a self-aligning manner in a shape conforming to the pattern of the conductive film. Then, by solidifying the applied functional liquid, a metal film is formed on the conductive film. Therefore, unlike the past method, it is not necessary to perform a surface treating step a plurality of times using a mask or the like, and in one surface treating step, a water repellent region and a hydrophilic region can be selectively formed at the same time. Accordingly, the production process can be simplified and a high-definition patterned film can be formed.

### Application Example 2

An application example 2 is directed to the process for producing a patterned film-formed member according to the above application example, wherein a surface treatment agent containing a silane compound is used in the surface treating step.

According to this configuration, the silane compound reacts with water on the surface of the glassy material layer, and the surface of the glassy material layer is trimethylsilylated, whereby high water repellency can be imparted to the surface of the glassy material layer. On the other hand, the reactivity of the silane compound with the surface of the conductive film is low. That is, the hydrophilicity of the surface of the conductive film is maintained. Therefore, a contrasting pattern of a region having high water repellency (glassy material layer) and a region having low water repellency (conductive film) can be formed in the base material at the same time.

### Application Example 3

An application example 3 is directed to the process for producing a patterned film-formed member according to the above application example, wherein the surface treatment agent containing hexamethyldisilazane is used in the surface treating step.

According to this configuration, the surface treatment for the base material is performed using hexamethyldisilazane. That is, an HMDS treatment is performed. Hexamethyldisilazane and water (—OH) on the surface of the glassy material layer are reacted with each other to generate ammonia (NH3), and also the surface of the glassy material layer is trimethylsilylated (—Si(CH3)3). That is, the surface of the glassy material layer is subjected to a water repellent treatment. On the other hand, since the reactivity of hexamethyldisilazane with the surface of the conductive film is low, the hydrophilicity of the surface of the conductive film is maintained. Therefore, a contrasting pattern of a region having high water repellency (glassy material layer) and a region having low water repellency (conductive film) can be formed in the base material at the same time.

### Application Example 4

An application example 4 is directed to the process for producing a patterned film-formed member according to the above application example, wherein the base material and the surface treatment agent containing hexamethyldisilazane are left in a hermetically sealed environment, and the base material is exposed for 3 to 15 minutes in an atmosphere in which the hexamethyldisilazane is vaporized at normal temperature in the surface treating step.

According to this configuration, a region having high water repellency (glassy material layer) and a region having low water repellency (conductive film) can be easily formed at the same time.

### Application Example 5

An application example 5 is directed to the process for producing a patterned film-formed member according to the above application example, wherein the surface of the glassy material layer is subjected to the water repellent treatment such that a contact angle of the surface of the glassy material layer with water is 50° or more, and the surface of the conductive film is subjected to the water repellent treatment such that a contact angle of the surface of the conductive film with water is 25° or less in the surface treating step.

According to this configuration, the aqueous functional liquid can be repelled from the surface of the glassy material layer and can be allowed to wet and spread on the surface of the conductive film. Therefore, it is possible to create a liquid state of the functional liquid in a shape conforming to the pattern of the conductive film.

### Application Example 6

An application example 6 is directed to the process for producing a patterned film-formed member according to the above application example, wherein the surface of the glassy material layer is subjected to the water repellent treatment such that a contact angle of the surface of the glassy material layer with the functional liquid is 40° or more, and the surface of the conductive film is subjected to the water repellent treatment such that a contact angle of the surface of the conductive film with the functional liquid is 30° or less in the surface treating step.

According to this configuration, the aqueous functional liquid can be repelled from the surface of the glassy material layer and can be allowed to wet and spread on the surface of the conductive film. Therefore, it is possible to create a liquid state of the functional liquid in a shape conforming to the pattern of the conductive film.

### Application Example 7

An application example 7 is directed to the process for producing a patterned film-formed member according to the above application example, wherein the functional liquid is applied onto the conductive film by ejecting the functional liquid in the form of liquid droplets in the applying step.

According to this configuration, the functional liquid can be efficiently applied to a desired position and a high-definition pattern can be formed.

### Application Example 8

An application example 8 is directed to the process for producing a patterned film-formed member according to the above application example, wherein the functional liquid is applied such that a dot of the liquid droplet applied onto the conductive film comes into contact with adjacent another dot of the liquid droplet in the applying step.

According to this configuration, the dots of the applied liquid droplets are connected in a beaded form, and therefore, the functional liquid can be easily moved in a self-aligning manner in a shape conforming to the pattern of the conductive film.

### Application Example 9

An application example 9 is directed to the process for producing a patterned film-formed member according to the above application example which further includes a leaving step of leaving the base material having the functional liquid applied thereonto between the applying step and the solidifying step.

According to this configuration, by leaving the base material having the functional liquid applied thereonto, a period for which the functional liquid moves in a self-aligning manner in a shape conforming to the pattern of the conductive film can be secured. Further, in the case where the functional liquid is ejected in the form of liquid droplets, a period for which adjacent dots of the liquid droplets are joined together can be secured, and therefore, it is possible to create a liquid state in a shape conforming to the pattern of the conductive film.

### Application Example 10

An application example 10 is directed to a patterned film-formed member produced by the process for producing a patterned film-formed member according to the above application example.

According to this configuration, a high-definition and high-quality patterned film-formed member can be provided. In this case, examples of the patterned film-formed member include a touch panel, a color filter, a PDP member, an organic EL member, and an FED (field emission display) member.

### Application Example 11

An application example 11 is directed to an electrooptical device which includes the patterned film-formed member according to the above application example.

According to this configuration, an electrooptical device including the patterned film-formed member having high reliability can be provided. In this case, examples of the electrooptical device include a liquid crystal display, a plasma display, an organic EL display, and an FED (field emission display).

### Application Example 12

An application example 12 is directed to an electronic apparatus which includes the electrooptical device according to the above application example.

According to this configuration, an electronic apparatus including the electrooptical device having high reliability can be provided. In this case, examples of the electronic apparatus include a television receiver, a personal computer, a portable electronic apparatus, and a variety of other electronic products each of which has a color filter, a plasma display, an organic EL display, or an FED (field emission display) mounted thereon.

### BRIEF DESCRIPTION OF THE DRAWINGS

The invention will be described with reference to the accompanying drawings, wherein like numbers reference like elements.

FIG. 1 is a plan view showing a structure of a touch panel as a patterned film-formed member.

FIG. 2 is a cross-sectional view showing a structure of a touch panel as a patterned film-formed member.

FIG. 3 is a flowchart showing a process for producing a touch panel.

FIG. 4 is a flowchart showing a part of a process for producing a touch panel.

FIG. 5 is a schematic view showing a structure of a surface treatment device.

FIG. 6 is a perspective view showing a structure of a liquid droplet ejection device.

FIG. 7 is a cross-sectional view showing a structure of an ejection head.

FIGS. 8A to 8D are process drawings showing a process for producing a touch panel.

FIGS. 9A to 9C are process drawings showing a process for producing a touch panel.

FIGS. 10A and 10B are graphs showing measurement data of a contact angle for a base material.

FIGS. 11A to 11D are schematic views showing a state of a base material subjected to a surface treatment.

FIGS. 12A to 12C are schematic views showing a state in which a functional liquid is applied.

FIGS. 13A and 13B are a plan view and a cross-sectional view, respectively, showing a structure of a liquid crystal display device as an electrooptical device.

FIG. 14 is a perspective view showing a structure of a personal computer as an electronic apparatus.

### DESCRIPTION OF EXEMPLARY EMBODIMENTS

Hereinafter, embodiments of the invention will be described with reference to the accompanying drawings. Incidentally, the respective members in the respective drawings are shown in a recognizable size in the drawings, and thus the reduced scales, numbers, etc. are different for the respective members.

### Structure of Patterned Film-Formed Member

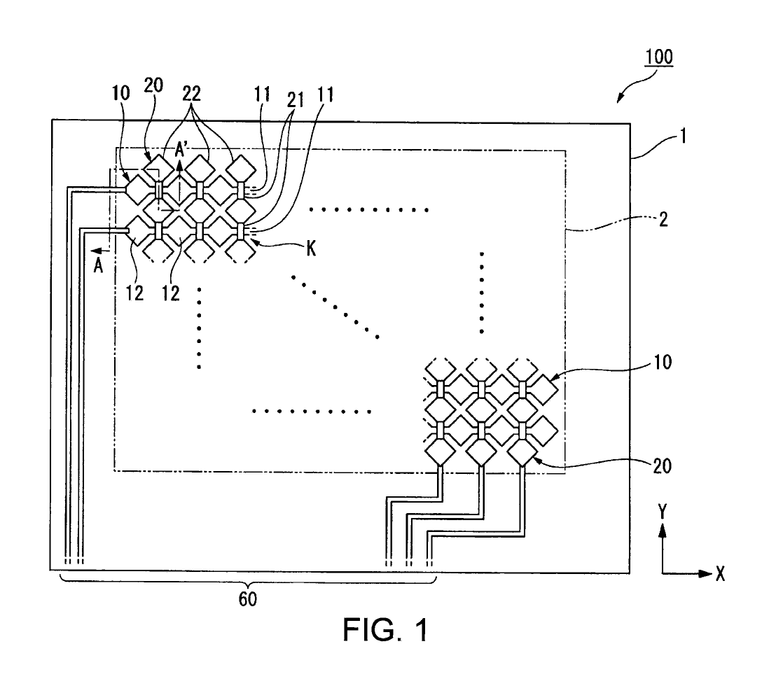

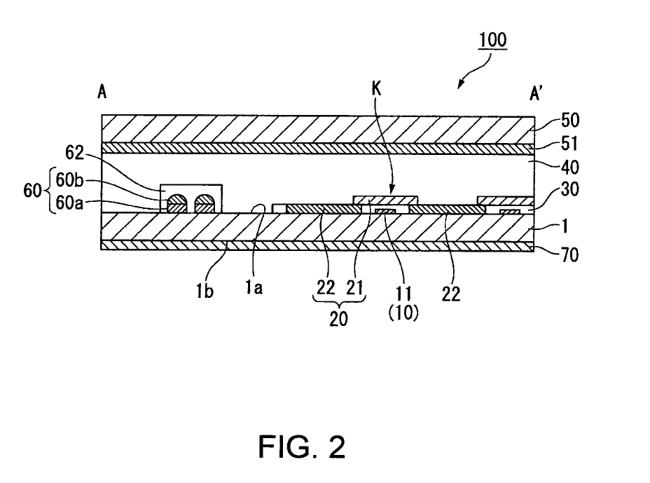

First, a structure of a patterned film-formed member is described. Incidentally, in this embodiment, a touch panel is cited as an example of the patterned film-formed member. FIG. 1 is a plan view showing a structure of a touch panel, and FIG. 2 is a cross-sectional view taken from line A-A′ of the touch panel shown in FIG. 1.

A touch panel 100 has a glass substrate 1, an input region 2, and drawing lines 60. The glass substrate 1 is transparent and includes a glassy material layer formed in a rectangular shape in a plan view.

The input region 2 is a region which is surrounded by the two-dot chain line in FIG. 1 and in which the positional information of a finger input to the touch panel 100 is detected. In the input region 2, a plurality of X electrodes (first electrodes) 10 and a plurality of Y electrodes (second electrodes) 20 are arranged, respectively. Each X electrode 10 extends in the x-axis direction in FIG. 1 and a plurality of the X electrodes 10 are arranged spaced from one another in the y-axis direction. Each Y electrode 20 extends in the y-axis direction in FIG. 1 and a plurality of the Y electrodes 20 are arranged spaced from one another in the x-axis direction. The X electrodes 10 and the Y electrodes 20 intersect with each other at intersection portions K in the input region 2 such that the bridge lines of the respective electrodes intersect with each other.

The X electrode 10 has a plurality of island-shaped electrode portions 12 arranged in the x-axis direction and bridge lines 11 which connect adjacent island-shaped electrode portions 12. The island-shaped electrode portions 12 have a rectangular shape in a plan view and are arranged such that one of the diagonal lines thereof is parallel to the x-axis.

The Y electrode 20 has a plurality of island-shaped electrode portions 22 arranged in the y-axis direction and bridge lines 21 which connect adjacent island-shaped electrode portions 22. The island-shaped electrode portions 22 have a rectangular shape in a plan view and are arranged such that one of the diagonal lines thereof is parallel to the y-axis. The island-shaped electrode portions 12 and the island-shaped electrode portions 22 are alternately arranged in the x-axis and y-axis directions (checkered pattern arrangement), and in the input region 2, the rectangular island-shaped electrode portions 12 and 22 are arranged in a matrix in a plan view.

As a constituent material of the X electrode 10 and the Y electrode 20, a light-transmissive resistive material such as ITO (indium tin oxide), IZO (indium zinc oxide, registered trademark), or ZnO can be used.

The drawing lines 60 are connected to the X electrodes 10 and the Y electrodes 20, and also connected to a drive section and an electrical signal conversion/calculation section (not shown in the drawing) provided for an internal or external device of the touch panel 100.

Subsequently, the cross-sectional view of FIG. 2 is described. On a functional surface 1a of the glass substrate 1, island-shaped electrode portions 12 (not shown in the drawing), the island-shaped electrode portions 22, and the bridge lines 11 are provided. On the bridge line 11, an insulating film 30 is formed with a thickness such that the upper surface of the insulating film 30 is substantially flush with the upper surface of the island-shaped electrode portion 22. Then, the bridge line 21 is placed on the insulating film 30. The bridge line 11 of the X electrode 10 is thinner than the island-shaped electrode portion 22 and is formed to a thickness, for example, about half the thickness of the island-shaped electrode portion 22. Further, on the functional surface 1a of the glass substrate 1, the drawing line 60 is placed. The drawing line 60 has a first layer 60a which is a conductive film placed on the functional surface 1a of the glass substrate 1 and a second layer 60b which is a metal film and is laminated on the first layer 60a. Then, a line protective film 62 is formed so as to cover the drawing line 60.

A planarizing film 40 is formed so as to cover these electrodes and lines. On the planarizing film 40, a protective substrate 50 is placed through an adhesive layer 51. On a back surface 1b of the glass substrate 1, a shield layer 70 is provided.

The insulating film 30 provides electrical insulation between the bridge line 11 and the bridge line 21 which sterically intersect with each other. The insulating film 30 can be formed by applying polysiloxane, an acrylic resin, an acrylic monomer, or the like using a printing method and then drying and solidifying it. In the case of using polysiloxane, the insulating film 30 is an inorganic insulating film made of silicon oxide. On the other hand, in the case of using an acrylic resin or an acrylic monomer, the insulating film 30 is an organic insulating film made of a resin material. Here, a resin solution obtained by mixing JSR NN525E and EDM (diethylene glycol ethyl methyl ether) at 4:1 (weight ratio) is used.

As a constituent material of the insulating film 30, it is preferred to use a material having a dielectric constant of 4.0 or less, preferably 3.5 or less. By using such a material, a parasitic capacitance in the intersection portions of the bridge lines can be decreased, whereby the position detection performance of the touch panel can be maintained. Further, as the constituent material of the insulating film 30, it is preferred to use a material having a refractive index of 2.0 or less, preferably 1.7 or less. By using such a material, a difference in the refractive index between the insulating film 30 and the glass substrate 1, the X electrodes 10, or the Y electrodes 20 can be made small, whereby the pattern of the insulating film 30 can be prevented from being seen by a user.

The first layer 60a of the drawing line 60 is a conductive film which is the X electrode 10 or the Y electrode 20 extended to a region outside the input region 2, and is, for example, a transparent conductive film having transparency. The transparent conductive film is formed of a resistive material such as ITO or IZO. The second layer 60b is formed by being laminated on the first layer 60a and reduces the wiring resistance of the drawing line 60. The second layer 60b can be formed of an organic compound, nanoparticles, nanowires, or the like containing at least one compound selected from metals such as Au, Ag, Al, Cu, and Pd and carbons (graphite, nanocarbons such as carbon nanotubes) as a component. The constituent material of the second layer 60b is not particularly limited as long as it can reduce the sheet resistance to a value smaller than that of the first layer 60a.

The line protective film 62 which covers the drawing line 60 can be formed in the same manner as the insulating film 30 by a printing method using polysiloxane, an acrylic resin, an acrylic monomer, or the like as a constituent material. Therefore, the line protective film 62 can be formed simultaneously in the step of forming the insulating film 30.

The planarizing film 40 is formed so as to cover at least the input region 2 on the functional surface 1a of the glass substrate 1 and planarizes the irregularities of the functional surface 1a due to the X electrodes 10 and the Y electrodes 20. As shown in the drawing, it is preferred that the planarizing film 40 is formed so as to cover the substantially entire functional surface 1a (excluding external connection terminals). By planarizing the glass substrate 1 on the side of the functional surface 1a with the planarizing film 40, the glass substrate 1 and the protective substrate 50 can be uniformly bonded to each other over the substantially entire surface. Further, as a constituent material of the planarizing film 40, it is preferred to use a material having a refractive index of 2.0 or less, preferably 1.7 or less. By using such a material, a difference in the refractive index between the planarizing film 40 and the glass substrate 1, the X electrodes 10, or the Y electrodes 20 can be made small, whereby the wiring pattern of the X electrodes 10 and the Y electrodes 20 can be made difficult to see.

The protective substrate 50 is a transparent substrate of a glass, a plastic, or the like. In the case where the touch panel 100 according to this embodiment is disposed on the front surface of a display device such as a liquid crystal panel or an organic EL panel, as the protective substrate 50, an optical device substrate (such as a polarizing plate or a retardation plate) to be used as a part of the display device can also be used.

The shield layer 70 is formed by forming a film on the back surface 1b of the glass substrate 1 using a transparent conductive material such as ITO or IZO (registered trademark). Alternatively, a configuration in which a film having a transparent conductive film serving as the shield layer formed thereon is prepared, and this film is bonded to the back surface 1b of the glass substrate 1 may be employed. By providing the shield layer 70, the electric field on the side of the back surface 1b of the glass substrate 1 is blocked. Accordingly, the electric field of the touch panel 100 can be prevented from acting on a display device or the like, or the electric field of an external apparatus of a display device or the like can be prevented from acting on the touch panel 100. Incidentally, in this embodiment, the shield layer 70 is formed on the back surface 1b of the glass substrate 1, however, the shield layer 70 may be formed on the side of the functional surface 1a of the glass substrate 1.

Here, the principle of operation of the touch panel 100 is briefly described. First, a predetermined potential is supplied from the drive section (not shown in the drawing) to the X electrodes 10 and the Y electrodes 20 through the drawing lines 60. Meanwhile, to the shield layer 70, for example, a ground potential is supplied.

When a finger is brought close to the input region 2 on the side of the protective substrate 50 in a state where the potential is supplied as described above, a parasitic capacitance is formed between the finger brought close to the protective substrate 50 and each of the X electrode 10 and the Y electrode 20 in the vicinity of the position to which the finger is brought close. Then, in the X electrode 10 and the Y electrode 20 in which the parasitic capacitance has been formed, a temporary potential drop is caused for charging the parasitic capacitance.

In the drive section, the potential of each electrode is sensed, and the X electrode 10 and the Y electrode 20 in which the above-described potential drop has been caused are detected immediately. Then, by analyzing the positions of the detected electrodes by the electrical signal conversion/calculation section, the positional information of the finger in the input region 2 is detected. More specifically, by the X electrodes 10 extending in the x-axis direction, the y-coordinate at the position to which the finger is brought close in the input region 2 is detected, and by the Y electrodes 20 extending in the y-axis direction, the x-coordinate in the input region 2 is detected.

### Process for Producing Patterned Film-Formed Member

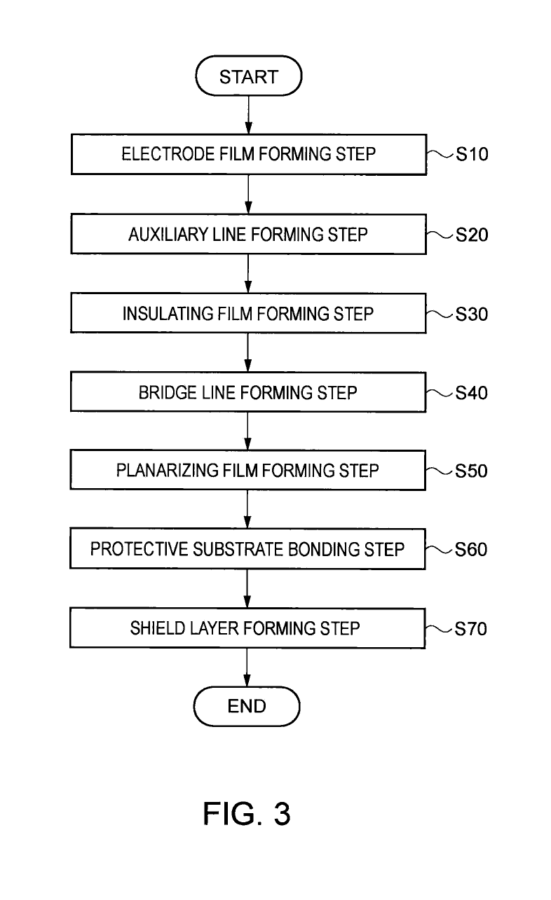

Subsequently, the process for producing a patterned film-formed member is described. Incidentally, in this embodiment, a touch panel is cited as an example of the patterned film-formed member, and a process for producing a touch panel is described. FIG. 3 is a flowchart showing a process for producing a touch panel.

A process for producing a touch panel according to this embodiment includes: an electrode film forming step S10 of forming island-shaped electrode portions 12 and 22, bridge lines 11, and a first layer 60a which is a conductive film of drawing lines 60 on a functional surface 1a of a glass substrate 1; an auxiliary line forming step S20 of laminating a second layer 60b which is a metal film on the first layer 60a of the drawing lines 60; an insulating film forming step S30 of forming an insulating film 30 on the bridge lines 11 and also forming a line protective film 62 which covers the drawing lines 60; abridge line forming step S40 of forming bridge lines 21 which connect adjacent island-shaped electrode portions 22 over the insulating film 30; a planarizing film forming step (a protective film forming step) S50 of forming a planarizing film 40 which planarizes the glass substrate 1 on the side of the functional surface 1a; a protective substrate bonding step (a bonding layer forming step) S60 of bonding a protective substrate 50 and the planarizing film 40 to each other through a bonding layer 51; and a shield layer forming step (a conductive film forming step) S70 of forming a shield layer 70 on a back surface 1b of the glass substrate 1.

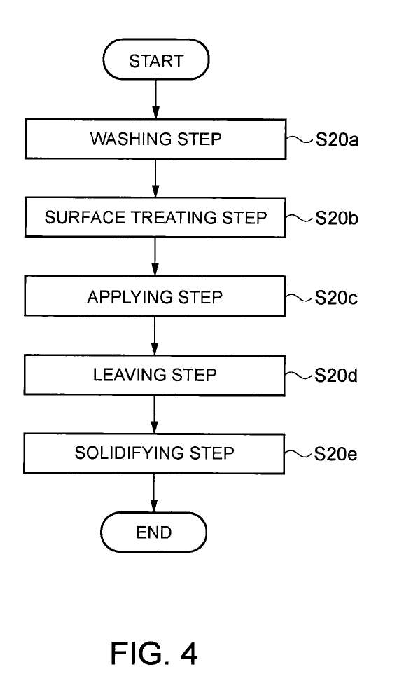

Further, FIG. 4 is a flowchart showing a part of the process for producing a touch panel. That is, FIG. 4 is a flowchart for illustrating the auxiliary line forming step S20 in the process for producing a touch panel in further detail.

As shown in FIG. 4, the auxiliary line forming step S20 includes a washing step S20a of washing a surface of a base material 1′ in which the first layer 60a serving as a conductive film has been formed on the functional surface 1a of the glass substrate 1; a surface treating step S20b of performing a surface treatment for the surface of the base material 1′; an applying step S20c of applying a functional liquid containing an aqueous dispersion medium and metal particles which are a constituent material of the second layer 60b serving as a metal film and are dispersed in the aqueous dispersion medium onto the first layer 60a; a leaving step S20d of leaving the base material 1′ onto which the functional liquid is adhered; and a solidifying step S20e of solidifying the applied functional liquid thereby forming the second layer 60b on the first layer 60a.

Incidentally, in this embodiment, a surface treatment device is used in the surface treating step S20b, and a liquid droplet ejection device is used in the applying step S20c and the like. Therefore, prior to a description of the process for producing a touch panel, a surface treatment device and a liquid droplet ejection device are described.

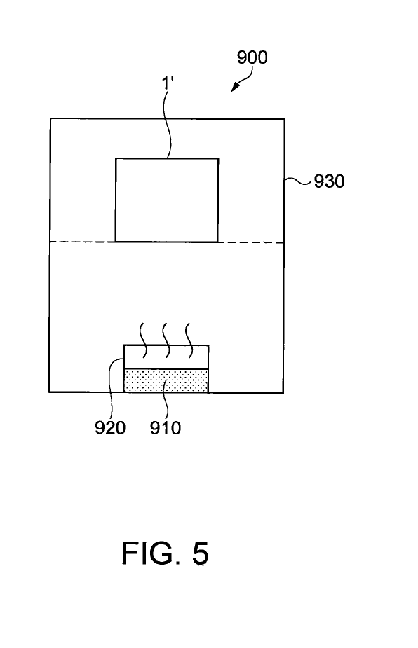

First, a surface treatment device is described. FIG. 5 is a schematic view showing a structure of a surface treatment device. A surface treatment device 900 is a device to be used for performing a surface treatment for a base material using hexamethyldisilazane as a surface treatment agent, and generally is a device to be used for performing an HMDS treatment. Incidentally, in this embodiment, a structure of the surface treatment device 900 employing a gaseous diffusion method is shown. The surface treatment device 900 has hexamethyldisilazane (HMDS) 910, a dish-shaped container 920 in which hexamethyldisilazane 910 is placed, and a housing case 930 in which the dish-shaped container 920 and the base material 1′ can be housed and hermetically sealed. In the case where a surface treatment is performed, in the housing case 930, the dish-shaped container 920 containing hexamethyldisilazane 910 and the base material 1′ (which is placed on the upper side of the dish-shaped container 920) are placed, respectively, and the housing case 930 is hermetically sealed. Then, hexamethyldisilazane 910 is vaporized, and the atmosphere of the inside of the housing case 930 is changed to an atmosphere of hexamethyldisilazane 910. Accordingly, the base material 1′ and hexamethyldisilazane 910 are reacted with each other thereby effecting the surface treatment for the base material 1′.

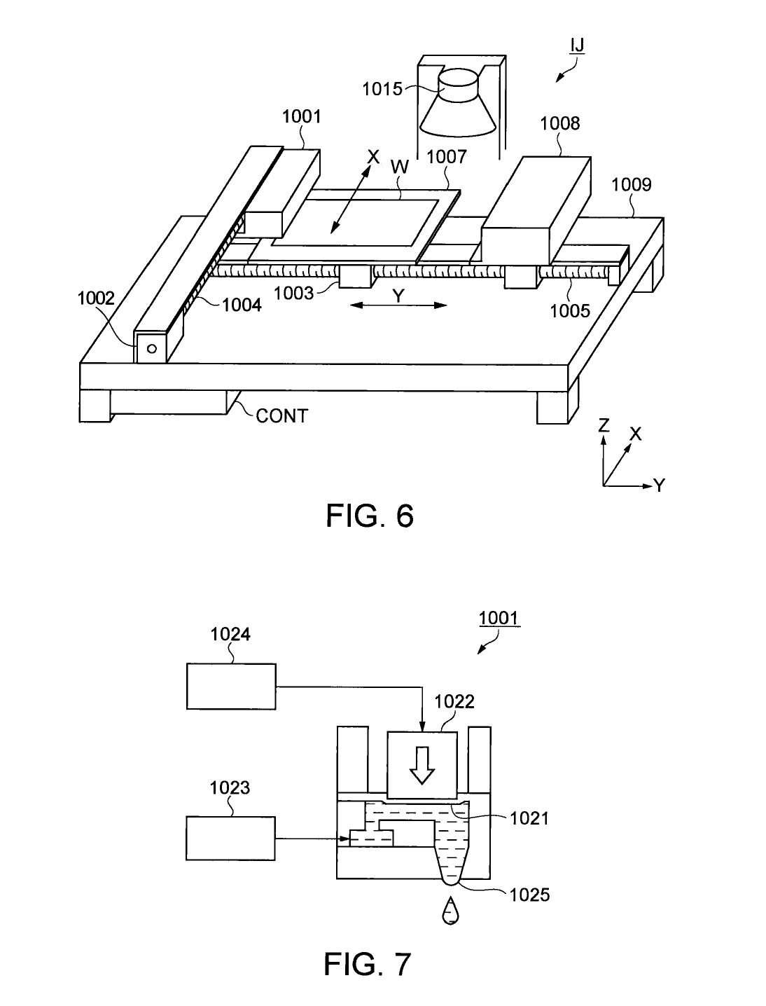

Subsequently, a liquid droplet ejection device is described. FIG. 6 is a perspective view showing a structure of a liquid droplet ejection device. A liquid droplet ejection device IJ has a liquid droplet ejection head 1001, an x-axis direction drive shaft 1004, y-axis direction guide shaft 1005, a controller CONT, a stage 1007, a cleaning mechanism 1008, a base 1009, and a heater 1015.

The stage 1007 supports a work W onto which the functional liquid is applied, and has a fixing mechanism (not shown in the drawing) for fixing the work W at a reference position.

The liquid droplet ejection head 1001 is a multi-nozzle type liquid droplet ejection head having a plurality of ejection nozzles, and the longitudinal direction and the x-axis direction coincide with each other. The plurality of ejection nozzles are provided in a bottom surface of the liquid droplet ejection head 1001 spaced apart at a fixed distance. The liquid droplet ejection device is configured such that the functional liquid is applied onto the work W by ejecting the functional liquid in the form of liquid droplets from the ejection nozzles of the liquid droplet ejection head 1001 onto the work W supported by the stage 1007.

To the x-axis direction drive shaft 1004, an x-axis direction drive motor 1002 is connected. This x-axis direction drive motor 1002 comprises a stepping motor or the like, and when it is supplied with a drive signal for the x-axis direction by the controller CONT, the x-axis direction drive motor 1002 causes the x-axis direction drive shaft 1004 to rotate. When the x-axis direction drive shaft 1004 rotates, the liquid droplet ejection head 1001 moves in the x-axis direction.

The y-axis direction guide shaft 1005 is fixed so as not to move with respect to the base 1009. The stage 1007 has a y-axis direction drive motor 1003. The y-axis direction drive motor 1003 comprises a stepping motor or the like, and when it is supplied with a drive signal for the y-axis direction by the controller CONT, the y-axis direction drive motor 1003 causes the stage 1007 to move in the y-axis direction.

The controller CONT supplies a voltage for controlling the ejection of liquid droplets to the liquid droplet ejection head 1001. Further, the controller CONT supplies a drive pulse signal for controlling the movement in the x-axis direction of the liquid droplet ejection head 1001 to the x-axis direction drive motor 1002, and supplies a drive pulse signal for controlling the movement in the y-axis direction of the stage 1007 to the y-axis direction drive motor 1003.

The cleaning mechanism 1008 cleans the liquid droplet ejection head 1001. The cleaning mechanism 1008 has a drive motor in the y-axis direction (not shown in the drawing). The cleaning mechanism 1008 moves along the y-axis direction guide shaft 1005 by the driving of the drive motor in the y-axis direction. The movement of the cleaning mechanism 1008 is also controlled by the controller CONT.

The heater 1015 herein is a unit to be used for heating the work W by lamp annealing. The heater 1015 vaporizes and dries a solvent contained in the functional liquid applied onto the work W. The operation of turning on and off of the heater 1015 is also controlled by the controller CONT.

The liquid droplet ejection device IJ ejects liquid droplets to the work W from the plurality of ejection nozzles arranged in a bottom surface of the liquid droplet ejection head 1001 in the x-axis direction while relatively scanning the liquid droplet ejection head 1001 and the stage 1007 which supports the work W.

FIG. 7 is a diagram illustrating the principle of ejection of the functional liquid using a piezo system. In FIG. 7, a piezo element 1022 is placed adjacently to a liquid chamber 1021 that stores the functional liquid. To the liquid chamber 1021, the functional liquid is supplied through a liquid material supplying system 1023 including a material tank that stores the functional liquid. The piezo element 1022 is connected to a drive circuit 1024. A voltage is applied to the piezo element 1022 through the drive circuit 1024 to deform the piezo element 1022. The liquid chamber 1021 is thus deformed and the functional liquid is ejected from an ejection nozzle 1025. In this case, by changing the value of the applied voltage, the amount of distortion of the piezo element 1022 is controlled. Further, by changing the frequency of the applied voltage, the speed of distortion of the piezo element 1022 is controlled. In the case where liquid droplets are ejected using the piezo system, heat is not applied to the material. Accordingly, the piezo system has an advantage that it has less effect on the composition of the material.

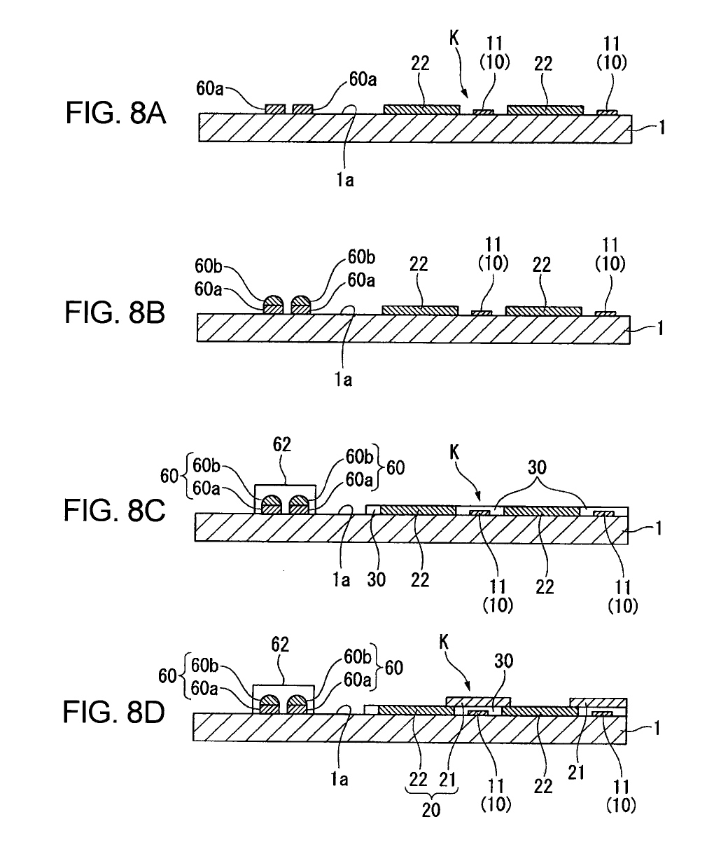

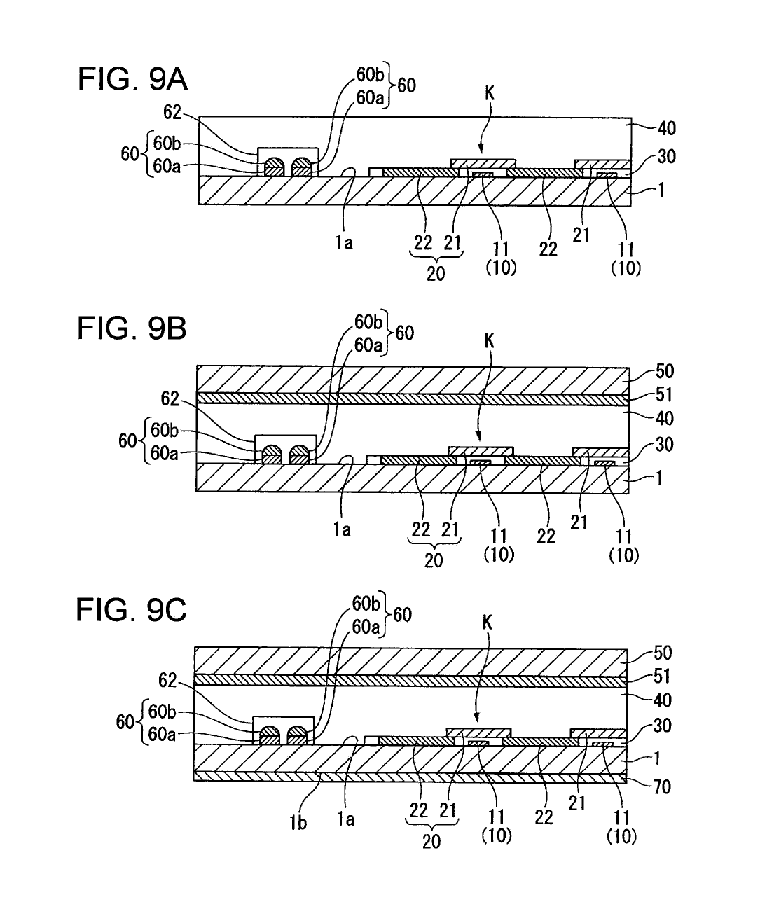

Here, returning to the description of the process for producing a touch panel. FIGS. 8A to 9C are process drawings showing the process for producing a touch panel.

First, the electrode film forming step S10 is described. In the electrode film forming step S10, liquid droplets of the functional liquid containing, for example, ITO particles are selectively placed on the glass substrate 1 using the liquid droplet ejection device IJ shown in FIG. 6. More specifically, on the glass substrate 1, the X electrodes 10 composed of the island-shaped electrode portions 12 and the bridge lines 11 are formed (a first electrode forming step), and also, the island-shaped electrode portions 22 which are part of the Y electrodes 20 are formed (a second electrode forming step), and then, the first layer 60a of the drawing lines 60 extended from the island-shaped electrode portions 12 and 22 is formed, whereby a pattern of the functional liquid comprising the X electrodes 10, the island-shaped electrode portions 22, and the first layer 60a is formed. Thereafter, the functional liquid (liquid droplets) placed on the glass substrate 1 is dried. By doing this, as shown in FIG. 8A, on the glass substrate 1, the X electrodes 10 (the island-shaped electrode portions 12 and the bridge lines 11), the island-shaped electrode portions 22, and the first layer 60a of the drawing lines 60 all of which are made of an ITO particle assembly are formed.

At this time, for example, the amount of the liquid droplets to be ejected is adjusted such that the bridge lines 11 are thinner than the island-shaped electrode portions 22. Further, in the case where the operation of liquid droplet ejection and drying is repeated a plurality of times, by reducing the number of the operations, the bridge lines 11 are formed such that the thickness thereof is smaller than that of the island-shaped electrode portions 22. Further, as for the Y electrodes 20, the island-shaped electrode portions 22 are formed such that they are separated by the intersection portions K and spaced from one another.

In the electrode film forming step S10 according to this embodiment, the ITO film is formed by ejecting liquid droplets containing ITO particles, however, a transparent conductive film made of IZO (registered trademark) may be formed using liquid droplets containing IZO (registered trademark) particles. Further, in the electrode film forming step S10, a pattern forming method using a photolithography method can also be used instead of a liquid droplet ejection method. That is, the X electrodes 10 (the island-shaped electrode portions 12 and the bridge lines 11), the island-shaped electrode portions 22, and the first layer 60a of the drawing lines 60 may be formed by forming an ITO film on the substantially entire functional surface 1a of the glass substrate 1 by a sputtering method or the like, and then patterning the formed ITO film using a photolithography method and an etching method.

Subsequently, the process proceeds to the auxiliary line forming step S20. First, in the washing step S20a of the auxiliary line forming step S20, the base material 1′ having the first layer 60a formed on the glass substrate 1 is washed. As the washing method, for example, washing with UV, washing with plasma, washing with HF (hydrofluoric acid), or the like can be used. Here, a contact angle of the glass substrate 1 with water after washing the base material 1′ is about 10° or less, and a contact angle of the first layer 60a with water is also about 10° or less. That is, the entire surface of the base material 1′ becomes a hydrophilic region.

Subsequently, in the surface treating step S20b, a surface of the base material 1′ is subjected to a surface treatment through an HMDS treatment by a gaseous diffusion method using the surface treatment device 900. Incidentally, in this embodiment, hexamethyldisilazane ((CH3)3SiNHSi(CH3)3)) 910 is used as the surface treatment agent. More specifically, the dish-shaped container 920 containing hexamethyldisilazane 910 is placed in the housing case 930, and also the base material 1′ is placed on the upper side of the dish-shaped container 920. Then, the housing case 930 is maintained in a hermetically sealed state, and the base material 1′ is exposed in an atmosphere in which hexamethyldisilazane 910 is vaporized.

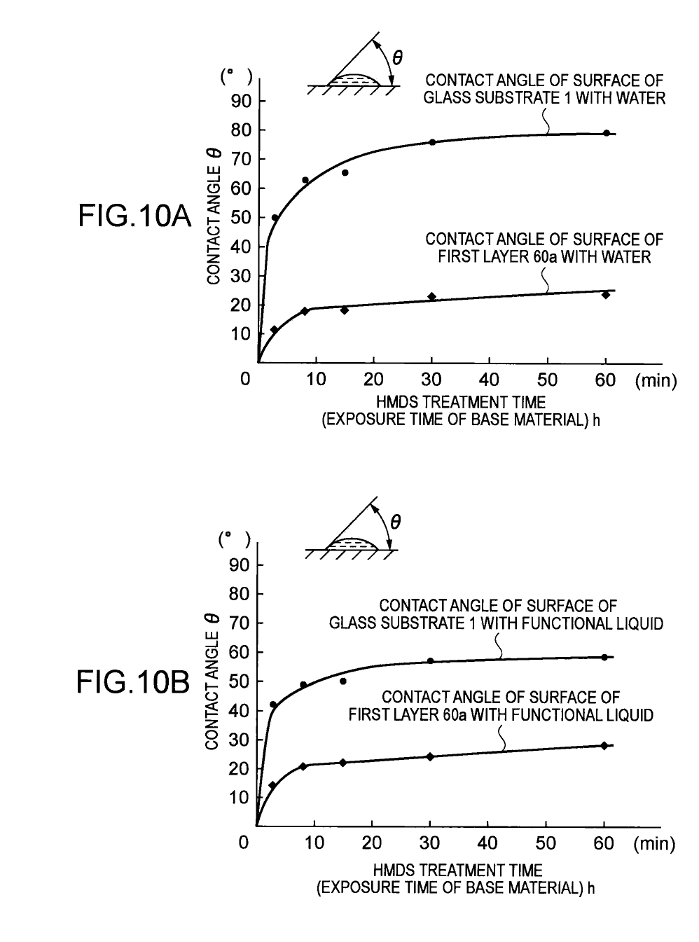

The conditions for the surface treatment for the base material 1′ can be suitably determined in consideration of the structure of the base material 1′, the properties of the functional liquid to be applied in the later step, and the like. Here, the conditions for the surface treatment are described by showing a specific example. FIGS. 10A and 10B are graphs showing measurement data of a contact angle for the base material. FIG. 10A is a graph showing measurement data of a contact angle θ of the surface of the glass substrate 1 with water and a contact angle θ of the surface of the first layer 60a with water, in which the horizontal axis indicates the surface treatment time h and the longitudinal axis indicates the contact angle θ. FIG. 10B is a graph showing measurement data of a contact angle θ of the surface of the glass substrate 1 with the functional liquid and a contact angle θ of the surface of the first layer 60a with the functional liquid, in which the horizontal axis indicates the surface treatment time h and the longitudinal axis indicates the contact angle θ. Here, hexamethyldisilazane 910 during the surface treatment is in a vaporized state at normal temperature (about 20 to 25° C.) Further, the functional liquid is a liquid material containing an aqueous dispersion medium and silver particles dispersed in the aqueous dispersion medium. As shown in FIG. 10A, the contact angle θ of the surface of the glass substrate 1 with water increases rapidly in about 20 minutes from the start of the surface treatment, and becomes 50° or more at the time point of 3 minutes from the start of the surface treatment time. Then, the contact angle θ gradually increases after 20 minutes from the start of the surface treatment. On the other hand, although the contact angle θ of the surface of the first layer 60a with water increases rapidly in about 10 minutes from the start of the surface treatment, the contact angle θ is kept not more than about 25°. Therefore, from FIG. 10A, it is found that by the surface treatment (HMDS treatment), a contrasting pattern of a region having high water repellency (the surface of the glass substrate 1) and a region having low water repellency (the first layer 60a) can be formed at the same time.

In addition, as shown in FIG. 10B, the contact angle θ of the surface of the glass substrate 1 with the functional liquid increases rapidly in about 10 minutes from the start of the surface treatment, and becomes 40° or more at the time point of 3 minutes from the start of the surface treatment. Then, the contact angle θ gradually increases after 10 minutes from the start of the surface treatment. On the other hand, although the contact angle θ of the surface of the first layer 60a with the functional liquid increases rapidly in about 10 minutes after the start of the surface treatment, the contact angle θ is kept not more than about 30°. Therefore, also from FIG. 10B, it is found that by the surface treatment (HMDS treatment), a region having high water repellency (the surface of the glass substrate 1) and a region having low water repellency (the first layer 60a) can be formed at the same time.

Therefore, in view of the measurement data shown in FIGS. 10A and 10B, the conditions for the surface treatment for the base material 1′ in this embodiment were determined such that hexamethyldisilazane 910 is vaporized at normal temperature, and the exposure time of the base material 1′ was about 3 to 15 minutes. Incidentally, the conditions for the surface treatment may be changed according to the processing state. For example, the exposure time of the base material 1′ may be determined to be 3 minutes or less, or 15 minutes or more (within 60 minutes).

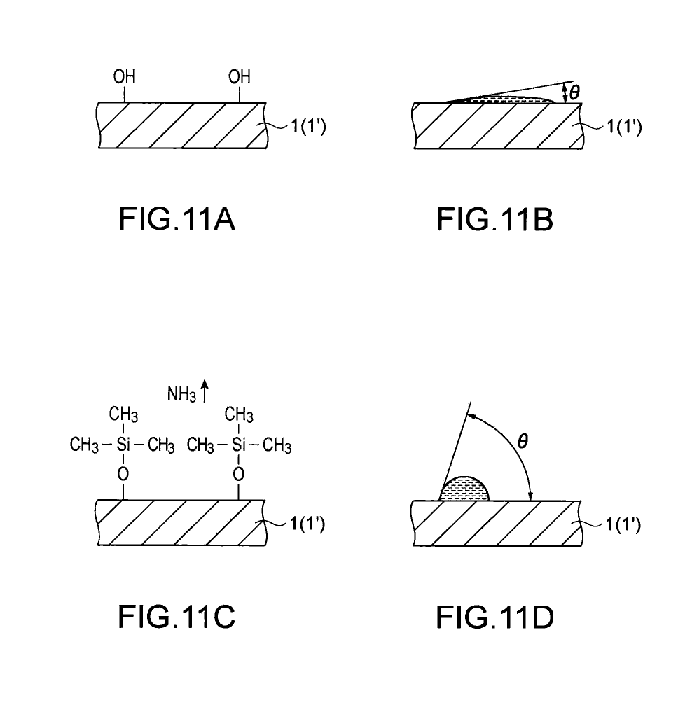

Subsequently, a state of the surface of the base material 1′ when the surface treatment is performed is described in further detail. FIGS. 11A to 11D are schematic views showing a state of a base material subjected to the surface treatment. FIG. 11A shows a state of the surface of the glass substrate 1 before the surface treatment (after the washing step S20a). In this state, a lot of hydroxy groups (—OH) are present on the surface of the glass substrate 1, and the surface of the glass substrate 1 has hydrophilicity. Therefore, as shown in FIG. 11B, a contact angle θ of the glass substrate 1 with water is about 10° or less. Also, the surface of the first layer 60a has hydrophilicity in the same manner as the surface state of the glass substrate 1, and a contact angle θ of the first layer 60a with water is about 10° or less. Here, as for the contact angle θ, an angle formed between a tangent of a liquid drawn from a contact point of three phases (vapor, liquid, and solid phases) to the liquid (in this embodiment, a water droplet) present on the surface of a solid (in this embodiment, the surface of the glass substrate 1 and the surface of the first layer 60a) in an atmosphere (air) and the surface of the solid on the side of the liquid is defined as the contact angle θ of the solid with this liquid. Therefore, as the contact angle of the surface of the glass substrate 1 is smaller, water droplets wet and spread on the surface more easily, in other words, the surface has higher hydrophilicity, and as the contact angle of the surface of the glass substrate 1 is larger, water droplets are repelled from the surface more easily, in other words, the surface has higher water repellency.

FIG. 11C shows a state of the surface of the glass substrate 1 after the surface treatment. As shown in FIG. 11C, hexamethyldisilazane 910 reacts with water (—OH) on the surface of the glass substrate 1 to generate ammonia (NH3), and the surface of the glass substrate 1 is trimethylsilylated (—Si(CH3)3). That is, the surface of the glass substrate 1 is subjected to a water repellent treatment. Therefore, as shown in FIG. 11D, a contact angle θ of the glass substrate 1 with water is about 50° or more which is larger than before the surface treatment. On the other hand, since the reaction of hexamethyldisilazane 910 with the surface of the first layer 60a proceeds slowly, the surface of the first layer 60a is subjected to a lower degree of water repellent treatment than that for the glass substrate 1. That is, the surface of the first layer 60a is subjected to a low degree of water repellent treatment (hydrophilicity is maintained). More specifically, a contact angle of the first layer 60a with water is about 25° or less. As described above, by the surface treating step S20b, in the base material 1′, a region having high water repellency (a region of the surface of the glass substrate 1) and a region having low water repellency (a region of the surface of the first layer 60a) can be formed at the same time.

Incidentally, in this embodiment, hexamethyldisilazane 910 is used as the surface treatment agent, however, other than this, for example, a silane compound such as trimethylmethoxysilane (CH3Si(OCH3)3) or trimethylchlorosilane ((CH3)3SiCl) can also be used. Further, in this embodiment, a gaseous diffusion method is used in the HMDS treatment, however, other than this, for example, a bubbling method in which nitrogen gas is blown into a bottle in which liquid HMDS is stored to effect bubbling, whereby HMDS vapor is generated, and the resulting HMDS vapor is ejected onto a base material may be used.

Subsequently, in the applying step S20c, the functional liquid containing an aqueous dispersion medium and metal particles which are a constituent material of the second layer 60b serving as the metal film and are dispersed in the aqueous dispersion medium is applied onto the first layer 60a of the drawing lines 60. As the metal material of the second layer 60b, a material having an electric resistivity lower than that of the first layer 60a is used. For example, a metal material containing silver particles can be used. Incidentally, as a material to be used for forming the second layer 60b other than the material containing silver particles, a material containing particles of a metal such as Au, Al, Cu, or Pd, or a material containing graphite or carbon nanotubes can be used. The metal particles or carbon particles are dispersed in the functional liquid in the form of nanoparticles or nanowires.

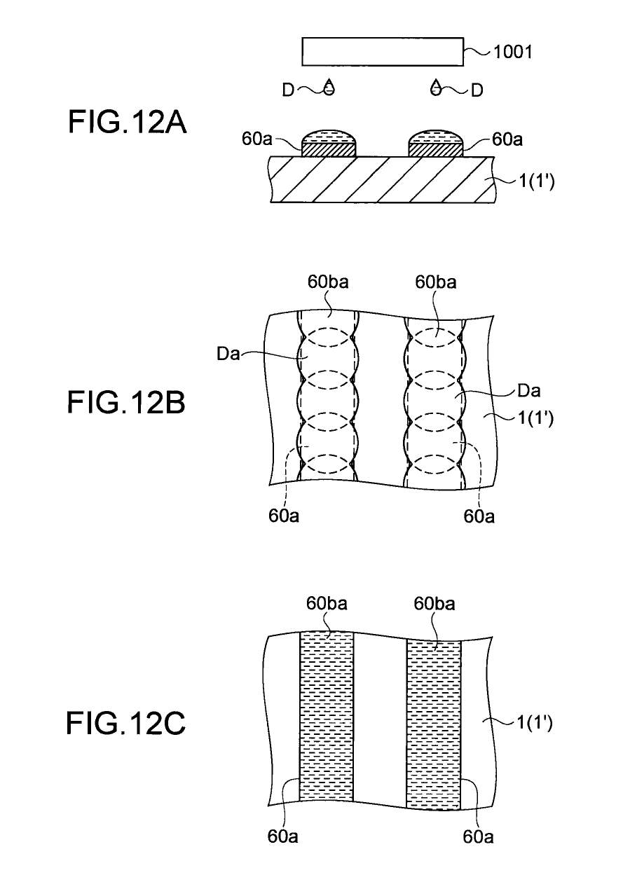

FIGS. 12A to 12C are schematic views showing a state in which the functional liquid is applied in the applying step S20c. As shown in FIG. 12A, in this embodiment, the functional liquid is applied onto the first layer 60a by ejecting the functional liquid in the form of liquid droplets D using the liquid droplet ejection device IJ. More specifically, the liquid droplet ejection head 1001 is driven to eject liquid droplets D while allowing the stage 1007 and the liquid droplet ejection head 1001 to relatively move to each other, whereby the liquid droplets D are adhered onto the first layer 60a. At this time, by taking into consideration a line width of the first layer 60a or a surface state of the first layer 60a, the amount of the liquid droplets D is appropriately determined. Incidentally, as for a contact angle of the functional liquid with the base material 1′, as shown in FIG. 10B, a contact angle θ of the glass substrate 1 with the functional liquid (liquid droplet D) is about 40° or more. On the other hand, a contact angle θ of the first layer 60a with the functional liquid (liquid droplet D) is about 30° or less. In the same manner as the contact angle with water, also with the functional liquid, a contrasting pattern of a region having high water repellency (a region of the surface of the glass substrate 1) and a region having low water repellency (a region of the surface of the first layer 60a) can be maintained by the surface treating step S20b.

FIG. 12B is a schematic plan view showing a state of liquid droplet dots Da formed by the landing of the liquid droplets D on the first layer 60a. The liquid droplets D ejected from the liquid droplet ejection head 1001 land on the first layer 60a, and the liquid droplet dots Da landing thereon wet and spread on the first layer 60a. Further, in the applying step S20c, the liquid droplets D are ejected a plurality of times such that the liquid droplet dot Da applied onto the first layer 60a comes into contact with adjacent another liquid droplet dot Da. As shown in FIG. 12B, the liquid droplet dots Da are connected with the adjacent liquid droplet dots Da in a beaded form, and a liquid surface in a liquid state caused by the application onto the first layer 60a has an irregular shape in a plan view. Incidentally, the applied liquid droplet dots Da wet and spread on the first layer 60a, however, they do not wet or spread on the surface of the glass substrate 1. It is because the surface of the glass substrate 1 has been subjected to the water repellent treatment, and the liquid droplet dots Da are prevented from wetting and spreading in a boundary region between the glass substrate 1 and the first layer 60a.

Subsequently, in the leaving step S20d, the base material 1′ onto which the functional liquid has been applied is left as such, for example, at normal temperature for about 1 to 10 minutes. FIG. 12C is a schematic view showing a liquid state after leaving the base material 1′. As shown in FIG. 12C, the functional liquid applied onto the first layer 60a is in a liquid state in a shape conforming to the pattern of the first layer 60a. That is, the liquid state in an irregular shape as shown in FIG. 12B changes to the liquid state in a shape conforming to the pattern of the first layer 60a, and in this embodiment, it changes to the liquid state in a shape conforming to the linear pattern of the first layer 60a. The reason is as follows. In the liquid state in an irregular shape shown in FIG. 12B, in the concave portions in which the liquid droplet dots Da are connected, since the surface of the first layer 60a has been subjected to a low degree of water repellent treatment (hydrophilicity is maintained), the functional liquid wets and spreads in the direction of the width of the line of the first layer 60a. On the other hand, in the convex portions, since the surface of the glass substrate 1 has been subjected to a high degree of water repellent treatment, the functional liquid is repelled in the boundary region between the first layer 60a and the glass substrate 1, and the repelled functional liquid moves toward the first layer 60a. In this manner, by leaving the base material 1′ as such, the functional liquid moves in a self-aligning manner and creates a liquid state in a shape conforming to the pattern of the first layer 60a. Incidentally, this leaving step S20d is provided in view of the time of self-aligning movement of the functional liquid applied onto the first layer 60a, and therefore, for example, in the case where the self-aligning movement is completed promptly, etc., the leaving step S20d can be omitted.

Subsequently, in the solidifying step S20e, the applied functional liquid is solidified to form the second layer 60b. For example, the base material 1′ is baked by heating at 230° C. for 1 hour. By doing this, as shown in FIG. 8B, the second layer 60b having a low resistance is formed on the first layer 60a, whereby the drawing line 60 having a two-layer structure is formed.

Subsequently, the insulating film forming step S30 and the bridge line forming step S40 are performed sequentially. In the insulating film forming step S30, as shown in FIG. 8C, liquid droplets are selectively placed in the space among the island-shaped electrode portions 12 and 22 so as to cover the bridge lines 11 of the X electrodes 10 using the liquid droplet ejection device IJ. At this time, at each intersection portion K, as shown in FIG. 8C, the island-shaped electrode portions 22 mark both ends of the insulating film 30 in the y-axis direction as partitions and define the profile shape of the insulating film 30 (in this embodiment, not only in the y-axis direction, but also in the other direction, the profile shape of the insulating film 30 is defined). Thereafter, the liquid material on the glass substrate 1 is dried and solidified by heating, whereby the insulating film 30 covering the bridge line 11 is formed.

Incidentally, when the insulating film 30 is formed, it is preferred that the liquid droplets are placed with no space at least in the regions on the bridge lines 11. By doing this, the insulating film 30 with no holes or cracks reaching the bridge lines 11 can be formed, and insulation failure of the insulating film 30 or disconnection of bridge lines 21 is prevented.

At this time, since the insulating film 30 in the intersection portion K is in contact with the island-shaped electrode portions 22 serving as the partitions, a surface tension acts on, and therefore, the film is formed such that the upper surface of the insulating film 30 is substantially flush with the upper surfaces of the island-shaped electrode portions 22 in a state where elevation of both ends of the insulating film 30, so-called, oozing up thereof is prevented.

Subsequently, as shown in FIG. 8C, liquid droplets are selectively placed also in the regions on the drawing lines 60. Thereafter, a liquid material on the glass substrate 1 is dried and solidified by heating, whereby the line protective film 62 which covers the drawing lines 60 is formed. As the liquid material, for example, a liquid material containing polysiloxane or a liquid material containing an acrylic resin or an acrylic monomer can be used.

Subsequently, the process proceeds to the bridge line forming step S40. In the bridge line forming step S40, as shown in FIG. 8D, liquid droplets of a liquid material containing ITO particles are placed in the form of a line over the island-shaped electrode portions 22 adjacent to each other and the insulating film 30. Thereafter, the liquid material on the glass substrate 1 is dried and solidified. By doing this, the bridge line 21 which connects the island-shaped electrode portions 22 is formed. When the bridge line 21 is formed, as described above, the insulating film 30 in the intersection portion K to serve as an underlying layer has been made substantially flat by defining the profile shape of the insulating film 30 with the partitions (the island-shaped electrode portions 22), whereby the bridge line 21 is formed in the shape of a line without bending unlike the case where oozing up is caused in the underlying layer. Incidentally, as for the liquid material to be used in the formation of the bridge line 21, a liquid material containing IZO (registered trademark) or ZnO particles can also be used other than the liquid material containing ITO particles described above.

In the bridge line forming step S40, it is preferred to form the bridge line 21 using the same liquid material as that in the electrode film forming step S10. That is, as the constituent material of the bridge line 21, it is preferred to use the same material as the constituent material of the X electrode 10 and the island-shaped electrode portion 22.

Subsequently, the process proceeds to the planarizing film forming step S50. In the planarizing film forming step S50, as shown in FIG. 9A, for the purpose of planarizing the functional surface 1a of the glass substrate 1, the planarizing film 40 made of an insulating material is formed on the substantially entire surface of the functional surface 1a. The planarizing film 40 can be formed using the same liquid material as that for forming the insulating film 30 used in the insulating film forming step S30, however, the planarizing film 40 is formed for the purpose of planarizing the surface of the glass substrate 1, and therefore, it is preferred to form the planarizing film 40 using a resin material.

Subsequently, the process proceeds to the protective substrate bonding step S60. In the protective substrate bonding step S60, as shown in FIG. 9B, an adhesive is placed between the planarizing film 40 and a separately prepared protective substrate 50, and the protective substrate 50 and the planarizing film 40 are bonded to each other through an adhesive layer 51 made of the adhesive. The protective substrate 50 may be an optical device substrate such as a polarizing plate or a retardation plate as well as a transparent substrate made of a glass or a plastic. As the adhesive constituting the adhesive layer 51, a transparent resin material or the like can be used.

Subsequently, the process proceeds to the shield layer forming step S70. In the shield layer forming step S70, as shown in FIG. 9C, the shield layer 70 constituted of a conductive film is formed on the back surface 1b (a surface on the opposite side from the functional surface 1a) of the glass substrate 1. The shield layer 70 can be formed using a known film forming method such as a vacuum film forming method, a screen printing method, an offset method, or a liquid droplet ejection method. For example, in the case where the shield layer 70 is formed using a printing method such as a liquid droplet ejection method, a liquid material containing ITO particles or the like to be used in the electrode film forming step S10 and the bridge line forming step S40 can be used. Further, other than the method of forming the shield layer 70 by forming a film on the glass substrate 1, the following method may be employed. A film in which a conductive film has been formed on one surface or both surfaces thereof is separately prepared and bonded to the back surface 1b of the glass substrate 1, and the conductive film on the film is used as the shield layer 70.

Incidentally, in this embodiment, the shield layer 70 is formed at the end of the process for producing a touch panel, however, the shield layer 70 can be formed at any time. For example, the glass substrate 1 in which the shield layer 70 has been formed in advance can be subjected to the electrode film forming step S10 and the other steps thereafter. Further, the shield layer forming step can be performed between any steps from the electrode film forming step S10 to the protective substrate bonding step S60.

Further, in this embodiment, the shield layer 70 is formed on the back surface 1b of the glass substrate 1, however, in the case where a shield layer 70A is formed on the side of the functional surface 1a of the glass substrate 1, prior to the electrode film forming step S10, the step of forming the shield layer 70A and the step of forming an insulating film 80A are performed. Also in this case, the shield layer 70A can be formed in the same manner as the shield layer forming step S70. Further, the step of forming the insulating film 80A can be performed in the same manner as, for example, the insulating film forming step S30.

### Structure of Electrooptical Device

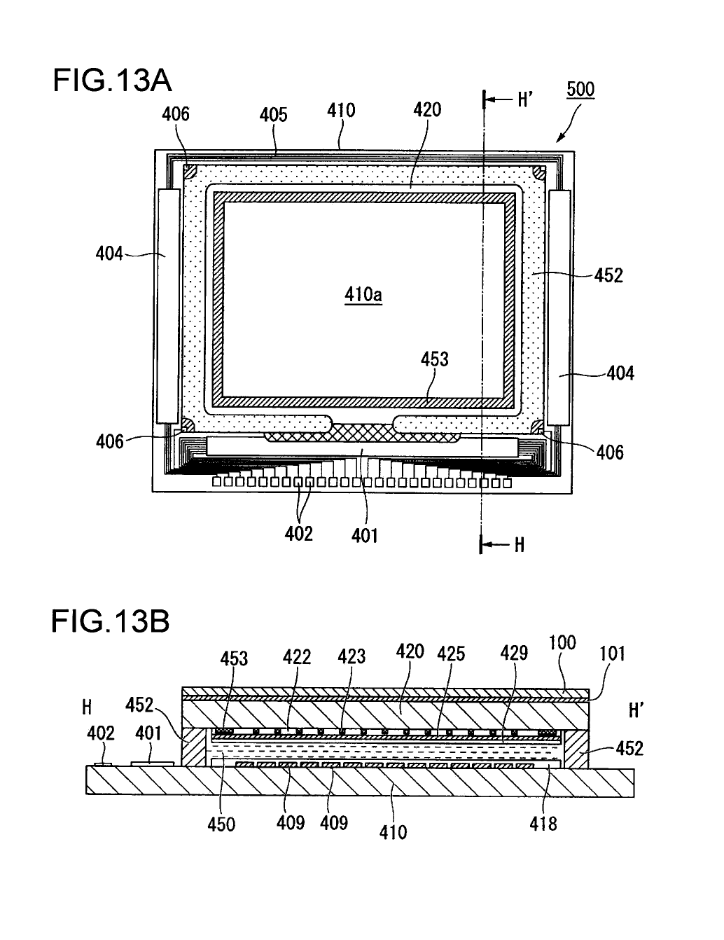

Subsequently, a structure of an electrooptical device is described. Incidentally, in this embodiment, a liquid crystal display device is cited as an example of the electrooptical device, and a structure of a liquid crystal display device having the above-described touch panel is described. FIGS. 13A and 13B show a structure of a liquid crystal display device; FIG. 13A is a plan view and FIG. 13B is a cross-sectional view taken from line H-H′ of the plan view of FIG. 13A.

As shown in FIG. 13A, a liquid crystal display device 500 has a device substrate 410, a counter substrate 420, and an image display region 410a. The device substrate 410 is a rectangular substrate having a flat region wider than the counter substrate 420. The counter substrate 420 is a transparent substrate formed of a glass or an acrylic resin and is disposed on the image display side of the liquid crystal display device 500. The counter substrate 420 is bonded in the center portion of the device substrate 410 through a sealant 452. The image display region 410a is a flat region of the counter substrate 420 and is an inner region of a peripheral margin 453 provided along an inner periphery of the sealant 452.

Around the periphery of the counter substrate 420 in the device substrate 410, a data line driving circuit 401, scanning line driving circuits 404, connection terminals 402 connected to the data line driving circuit 401 and the scanning line driving circuits 404, and wiring lines 405 for connecting the scanning line driving circuits 404 disposed at both sides of the counter substrate 420, and the like are placed.

Subsequently, a cross-section of the liquid crystal display device 500 is described. On a surface of the device substrate 410 on the side of a liquid crystal layer 450, pixel electrodes 409, an alignment film 418, and the like are laminated. On a surface of the counter substrate 420 on the side of the liquid crystal layer 450, a light-blocking film (black matrix) 423, a color filter 422, a common electrode 425, an alignment film 429, and the like are laminated. The liquid crystal layer 450 is sandwiched by the device substrate 410 and the counter substrate 420. On an outside surface of the counter substrate 420 (on the opposite side from the liquid crystal layer 450), the touch panel 100 according to the invention is provided through an adhesive layer 101.

### Structure of Electronic Apparatus

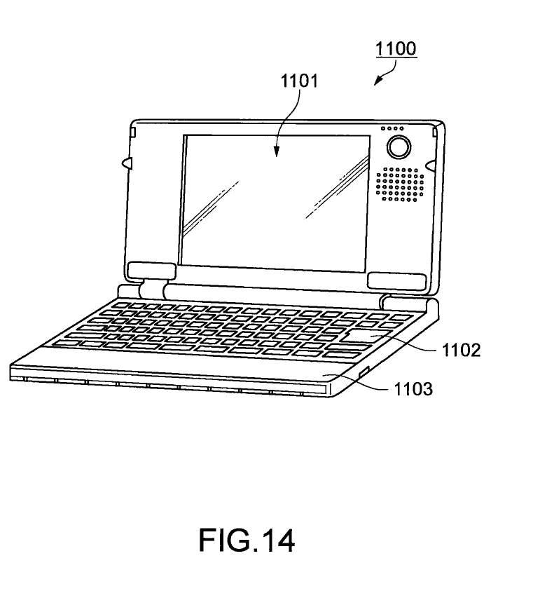

Subsequently, a structure of an electronic apparatus is described. Incidentally, in this embodiment, a mobile personal computer is cited as an example of the electronic apparatus, and a structure of a mobile personal computer on which the above-described touch panel or liquid crystal display device having the touch panel has been mounted is described. FIG. 14 is a perspective view showing a structure of a mobile personal computer. A mobile personal computer 1100 has a display section 1101 and a main body 1103 including a keyboard 1102. The mobile personal computer 1100 has the liquid crystal display device 500 according to the above embodiment in the display section 1101. According to the mobile personal computer 1100 having such a structure, since the touch panel according to the invention is used in the display section, an electronic apparatus whose production cost is reduced can be provided.

Incidentally, the above-described electronic apparatus is for illustrating the electronic apparatus according to the invention, and the technical scope of the invention is not limited thereto. For example, the touch panel according to the invention can also be preferably used in a display section of a cellular phone, a portable audio apparatus, a PDA (personal digital assistant), etc.

Hereinabove, preferred embodiments according to the invention have been described with reference to the accompanying drawings, however, it should be understood that the invention is not limited to these examples. The shapes, the combinations, and the like of the respective constituent members shown in the above-described examples are merely exemplary, and thus, various modifications can be made on the basis of a requirement of designing or the like without departing from the gist of the invention.

Therefore, according to the above embodiments, the following effect can be obtained.

(1) When the base material 1′ in which the first layer 60a has been formed on the glass substrate 1 is subjected to a surface treatment using hexamethyldisilazane 910, hexamethyldisilazane 910 reacts with water on the surface of the glass substrate 1, whereby the surface of the glass substrate 1 is trimethylsilylated. That is, the surface of the glass substrate 1 is subjected to a water repellent treatment. On the other hand, since the reaction of hexamethyldisilazane 910 with the surface of the first layer 60a proceeds slowly, the surface of the first layer 60a has low water repellency. That is, hydrophilicity of the surface of the first layer 60a is maintained. Therefore, by performing the above-described surface treatment, a region having water repellency and a region having hydrophilicity can be selectively formed at the same time. Accordingly, the production process can be simplified.

(2) A functional liquid containing an aqueous dispersion medium and a material of the second layer 60b dispersed in the aqueous dispersion medium is ejected in the form of liquid droplets onto the first layer 60a, whereby the functional liquid is applied onto the first layer 60a. Since the surface of the first layer 60a has low water repellency (has hydrophilicity), the applied functional liquid wets and spreads on the first layer 60a. On the other hand, since the surface of the glass substrate 1 has water repellency, the functional liquid is prevented from wetting and spreading on the glass substrate 1. Therefore, it is possible to allow the functional liquid to wet and spread in a shape conforming to the pattern of the first layer 60a. Then, by solidifying the functional liquid, the second layer 60b having a shape conforming to the pattern of the first layer 60a can be formed on the first layer 60a.

Incidentally, the invention is not limited to the above-described embodiments and includes a variation example as described below.

### Variation Example 1

In the above-described embodiments, a touch panel has been described as an example of the patterned film-formed member, however, the invention is not limited thereto, and for example, the invention may be applied to a plasma display, etc. Even by doing this, the same effect as described above can be obtained. Further, in the above-described embodiments, the first layer 60a is formed as a conductive film using a transparent conductive material such as ITO, however, the invention is not limited thereto, and the conductive film may be formed using another metal material. Even by doing this, the same effect as described above can be obtained.

### Variation Example 2

Various substrates may be used as the glass substrate 1 in the above embodiments and examples as long as they have a glassy material layer on their surface, and a film substrate formed of a glassy material layer and a substrate in which a glassy material layer is formed by coating or the like manner on a surface of a transparent material made of, for example, a transparent resin may be used. Advantages similar to those obtained above can be attained using such a substrate.

The entire disclosure of Japanese Patent Application Nos: 2009-140909, filed Jun. 12, 2009 and 2010-112888, filed May 17, 2010 are expressly incorporated by reference herein.

What is claimed is:

1. A process for producing a patterned film-formed member, comprising:
a surface treating step of subjecting a surface of a glassy material layer within a base material having a conductive film formed on a portion of the glassy material layer to a water repellent treatment and also subjecting a surface of the conductive film to a lower degree of water repellent treatment than that for the glassy material layer;
an applying step of applying a functional liquid containing an aqueous dispersion medium and metal particles which are a constituent material of a metal film and are dispersed in the aqueous dispersion medium onto the conductive film; and
a solidifying step of solidifying the applied functional liquid thereby forming the metal film on the conductive film.

2. The process for producing a patterned film-formed member according to claim 1, wherein, in the surface treating step, a surface treatment agent containing a silane compound is used.

3. The process for producing a patterned film-formed member according to claim 2, wherein, in the surface treating step, the surface treatment agent containing hexamethyldisilazane is used.

4. The process for producing a patterned film-formed member according to claim 3, wherein, in the surface treating step, the base material and the surface treatment agent containing hexamethyldisilazane are left in a hermetically sealed environment, and the base material is exposed for 3 to 15 minutes in an atmosphere in which the hexamethyldisilazane is vaporized at normal temperature.

5. The process for producing a patterned film-formed member according to claim 1, wherein, in the surface treating step, the surface of the glassy material layer is subjected to the water repellent treatment such that a contact angle of the surface of the glassy material layer with water is 50° or more, and the surface of the conductive film is subjected to the water repellent treatment such that a contact angle of the surface of the conductive film with water is 25° or less.

6. The process for producing a patterned film-formed member according to claim 1, wherein, in the surface treating step, the surface of the glassy material layer is subjected to the water repellent treatment such that a contact angle of the surface of the glassy material layer with the functional liquid is 40° or more, and the surface of the conductive film is subjected to the water repellent treatment such that a contact angle of the surface of the conductive film with the functional liquid is 30° or less.

7. The process for producing a patterned film-formed member according to claim 1, wherein, in the applying step, the functional liquid is applied onto the conductive film by ejecting the functional liquid in the form of liquid droplets.

8. The process for producing a patterned film-formed member according to claim 7, wherein, in the applying step, the functional liquid is applied such that a dot of the liquid droplet applied onto the conductive film comes into contact with adjacent another dot of the liquid droplet.

9. The process for producing a patterned film-formed member according to claim 1, wherein, the process further comprises, between the applying step and the solidifying step, a leaving step of leaving the base material having the functional liquid applied thereonto.

10. A patterned film-formed member, produced by the process for producing a patterned film-formed member according to claim 1.

11. An electrooptical device, comprising the patterned film-formed member according to claim 10.

12. An electronic apparatus, comprising the electrooptical device according to claim 11.
